(19) United States
(12) Patent Application Publication
(10) Pub. No.: US 2024/0203275 A1
(43) Pub. Date: Jun. 20, 2024

(54) TEACHING FEEDBACK SYSTEM AND TEACHING FEEDBACK METHOD

(71) Applicant: AIXlink Ltd., Chengdu City (CN)

(72) Inventor: Chih-Cheng LIN, Hsinchu City (TW)

(73) Assignee: AIXlink Ltd., Chengdu City (CN)

(21) Appl. No.: 18/169,886

(22) Filed: Feb. 16, 2023

(30) Foreign Application Priority Data
Dec. 19, 2022 (CN) 202211629743.6

(51) Int. Cl. G09B 5/00

(52) U.S. Cl. CPC G09B 5/00

(57) ABSTRACT

Disclosed are a teaching feedback system and a teaching feedback method. The teaching feedback system includes a server and an electronic device, and the server is linked to the electronic device. Data is pre-established in the server and the data is transmitted to the electronic device. After a user selects from the data received by the electronic device, the electronic device generates a demand signal, and transmits the demand signal and the selected data to the server. The server performs an adjustment according to the demand signal and the selected data. In this way, the user's need can be fed back, and a teaching method is adjusted according to individual needs, thereby achieving customization, and providing a better learning effect.

### CROSS-REFERENCE TO RELATED APPLICATION

This application claims the priority benefit of Chinese Patent Application Serial Number 202211629743.6, filed on Dec. 19, 2022, the full disclosure of which is incorporated herein by reference.

### BACKGROUND

### Technical Field

The present disclosure relates to the technical field of teaching, and particularly to a teaching feedback system and teaching feedback method.

### Related Art

In a traditional activity, an activity organizer provides a venue, and when an activity participant wants to participate in the event, he must go to the venue for physical interaction.

Based on the spread of the epidemic in the world, the people infected with the epidemic are isolated and treated to avoid the endless spread of the epidemic, so that the physical interaction is forced to be terminated, and a remote interactive electronic system is adopted instead. The remote interactive electronic system includes a first electronic device and a second electronic device, the first electronic device is wirelessly linked to the second electronic device. The activity organizer displays information or captures images through the first electronic device, and the information or the image is transmitted to the second electronic device, and then, the activity participant interacts with the information or the image through the second electronic device.

However, if the traditional activity is a sport activity, physical interaction must still be adopted. When athletes compete in the stadium, in order to avoid reducing the fighting spirit of the athletes, cardboard cutouts of the audiences are placed in the spectators seating to replace the audiences sitting in the spectators seating. In this way, in addition to the fact that the audience and the athletes cannot interact during the sport activity, after the sport activity is over, the cardboard cutouts of the audiences will be discarded and cannot be reused, which causes environmental burdens. Furthermore, there are also robots disposed in the venues to replace the audiences sitting in the spectators seating. Although the use of robots can provide interaction, the cost to be borne is too high to achieve the interaction.

Moreover, when the remote interactive electronic system transmits the information or the image to the second electronic device, the interaction is performed only with voice and facial expressions due to the limitation of the screen size, the bandwidth of the wireless connection, the number of users, etc.

Therefore, it is necessary to further provide a more improved solution for the prior art.

### SUMMARY

In view of the above-mentioned deficiencies in the prior art, the main purpose of the present disclosure is to provide a teaching feedback system and a teaching feedback method, in which the requirements can be fed back to perform an adjustment according to individual needs, thereby achieving customization and providing a better learning effect.

The main technical means taken for achieving the above-mentioned purpose is to make the teaching feedback system comprise: a server, configured to pre-establish a first data model and a second data model; and an electronic device, linked to the server; wherein the server transmits the first data model and the second data model to the electronic device; the electronic device performs a selection according to the first data model and the second data model, to generate a demand signal, and a selected first data model or a selected the second data model, and transmits the selected first data model or the selected second data model to the server; and the server establishes a user data model according to the selected first data model or the selected second data model.

Preferably, the teaching feedback system further comprises: a data collection electronic device, linked to the server, and configured to collect first characteristic data and second characteristic data, and transmit the first characteristic data and the second characteristic data to the server; wherein the server establishes the first data model and the second data model according to the first characteristic data and the second characteristic data.

Preferably, the server comprises: a communication unit, linked to the electronic device, and configured to receive user information from the electronic device; a storage unit, configured to store preset user information; and a processing unit, connected to the communication unit and the storage unit; wherein the processing unit compares the user information with the preset user information to determine whether the user information is consistent with the preset user information; and if yes, the processing unit establishes the user data model according to the user information, and the selected first data model or the selected second data model.

Preferably, the processing unit calculates the number of selections for the selected first data model to generate a number of selection times of the first data model, and calculates the number of selections for the selected second data model to generate a number of selection times of the second data model.

Preferably, the storage unit stores a selection threshold value; the processing unit compares the number of selection times of the first data model and the number of selection times of the second data model according to the selection threshold value, to determine whether the number of selection times of the first data model or the number of selection times of the second data model is less than the selection threshold value; and if yes, the processing unit deletes the first data model or the second data model.

Through above-mentioned architecture, the server can provide the first data model and the second data model to the electronic device, and a user can select a data model from the first data model and the second data model received by the electronic device, which meets his needs, and then the electronic device generates a demand signal corresponding thereto, and transmits the selected first data model or second data model to the server, so that the server establishes a user data model according to the first data model or the second data model. Thus, the speaker can adjust the teaching method according to individual needs through the feedback of the needs, to achieve customization and provide a better learning effect.

Another main technical means taken for achieving the above-mentioned purpose is to make a teaching feedback method applied in a teaching feedback system, wherein the teaching feedback system pre-establishes a first data model and a second data model, and the teaching feedback method performed by the teaching feedback system comprises the following steps: providing the first data model and the second data model; performing a selection from the first data model and the second data model to select the first data model or the second data model; and establishing a user data model according to the first data model or the second data model, which is selected.

Preferably, before the step of providing the first data model and the second data model, the teaching feedback method further comprises: obtaining first characteristic data and second characteristic data; and establishing the first data model and the second data model according to the first characteristic data and the second characteristic data.

Preferably, the step of establishing the user data model according to the first data model or the second data model, which is selected, comprises: obtaining user information; comparing the user information with preset user information to determine whether the user information is consistent with the preset user information; and if yes, establishing the user data model according to the first data model or the second data model, which is selected, and the user information.

Preferably, after the step of performing the selection from the first data model and the second data model to select the first data model or the second data model, the teaching feedback method further comprises: calculating the number of selections for the first data model or the second data model, which is selected, to generate a number of selection times of the first data model and a number of selection times of the second data model correspondingly; comparing the number of selection times of the first data model with the number of selection times of the second data model, to determine whether the number of selection times of the first data model is greater than the number of selection times of the second data model; if yes, setting the first data model corresponding to the number of selection times of the first data model as a default model; and if not, setting the second data model corresponding to the number of selection times of the second data model as the default model.

Preferably, the step of calculating the number of selections for the first data model or the second data model, which is selected, to generate the number of selection times of the first data model and the number of selection times of the second data model correspondingly, comprises: comparing the number of selection times of the first data model and the number of selection times of the second data model according to a selection threshold value, to determine whether the number of selection times of the first data model or the number of selection times of the second data model is less than the selection threshold value respectively; if yes, deleting the first data model or the second data model; and if not, performing the step of performing the selection from the first data model and the second data model to select the first data model or the second data model.

By above-mentioned method, the teaching feedback system can provide the first data model and the second data model to a user, and the user can select a data model from the first data model and the second data model, which meets his needs, and then the demand signal corresponding thereto is generated, and the user data model is established from the selected first data model or second data mode. Thus, the speaker can adjust the teaching method according to individual needs through the feedback of the needs, to achieve customization and provide a better learning effect.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is an architecture diagram of a specific embodiment of a teaching feedback system according to the present disclosure.

FIG. 2 is a block diagram of a specific embodiment of a teaching feedback system according to the present disclosure.

FIG. 3 is another block diagram of a specific embodiment of a teaching feedback system according to the present disclosure.

FIG. 4 is a schematic diagram of a first data model and a second data model of a teaching feedback system according to the present disclosure.

FIG. 5 is a flow chart of a specific embodiment of a teaching feedback method according to the present disclosure.

FIG. 6 is another flowchart of a specific embodiment of a teaching feedback method according to the present disclosure.

FIG. 7 is still another flowchart of a specific embodiment of a teaching feedback method according to the present disclosure.

FIG. 8 is yet another flowchart of a specific embodiment of a teaching feedback method according to the present disclosure.

FIG. 9 is still yet another flowchart of a specific embodiment of a teaching feedback method according to the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Based on the embodiments in the present disclosure, other embodiments obtained by those skilled in the art without creative efforts shall be within the scope of the present disclosure.

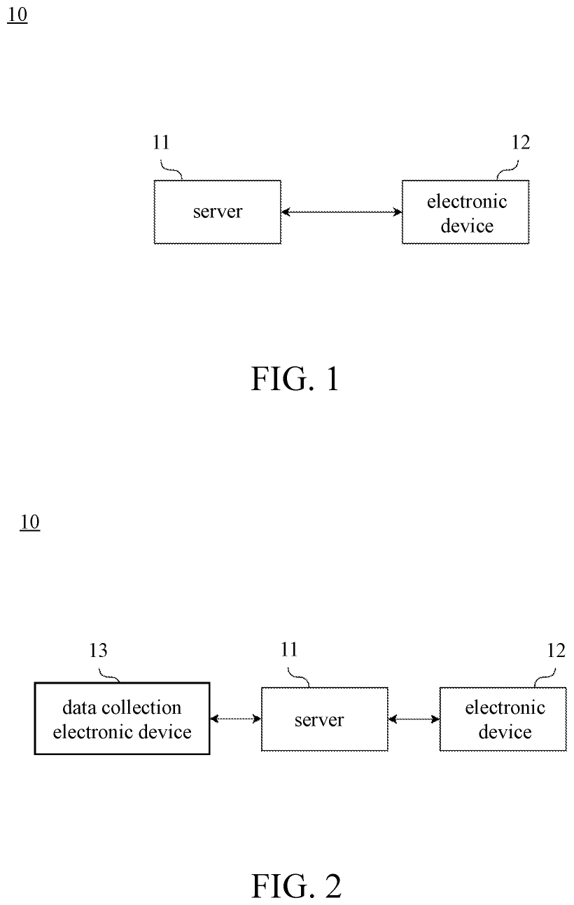

The preferred embodiment of a teaching feedback system 10 of the present disclosure is shown in FIG. 1. The teaching feedback system 10 comprises a server 11 and an electronic device 12, and the server 11 is linked to the electronic device 12 via a wired/wireless network. Data pre-established in the server 11 is transmitted to the electronic device 12. When a user adjusts the pre-established data received by the electronic device 12, the content adjusted by the user is sent back to the server 11 through the electronic device 12. Then, the server 11 adjusts the pre-established data according to the content adjusted by the user, so as to provide the adjusted content to the same user for next use.

In detail, a first data model and a second data model are pre-established in the server 11, and each of the first data model and the second data model includes first characteristic data and second characteristic data. The first characteristic data and the second characteristic data of the first data model and the second data model are transmitted to the electronic device 12. According to the first characteristic data and the second characteristic data of the first data model and the second data model, the first characteristic data or the second characteristic data of the first data model or the second data model is selected through the electronic device 12. According to the selected first characteristic data or the selected second characteristic data, a demand signal is generated. The demand signal, and the selected first characteristic data or the selected second characteristic data, are transmitted to the server 11, and the server 11 establishes a user data model according to the demand signal and the selected first characteristic data or the second characteristic data.

In the present embodiment, as shown in FIG. 2, the teaching feedback system 10 further comprises a data collection electronic device 13, and the data collection electronic device 13 is connected to the server 11. The teaching feedback system 10 is used to collect the first characteristic data and the second characteristic data for a speaker, such as a teacher, and transmit the first characteristic data and the second characteristic data to the server 11 to establish the first data model and the second data model.

In the present embodiment, each of the electronic device 12 and the data collection electronic device 13 is a desktop computer, a notebook computer, or a tablet computer. In present embodiment, the data collection electronic device 13 comprises an image capture device (not shown) or a sound receiving device (not shown).

In the present embodiment, each of the first characteristic data and the second characteristic data is voiceprint data, expression data, body motion image data, teaching content data, teaching expression data, etc. The voiceprint data can collect the tone and speech speed of the speaker through the sound receiving device, the expression data can be collected by the image capture device to collect the speaker's facial feature information, eye size, the curvature of the mouth corner, etc., and the body motion image data can be collected by the image capture device to collect the speaker's body swing and bend and swing speed. The first characteristic data and the second characteristic data of different speakers can be collected by the data collection electronic device 13, and then the first data model and the second data model can be established. In this example, the image capture device is a camera or a video camera, and the sound receiving device is a microphone.

In the present embodiment, the first characteristic data is different from the second characteristic data. For example, when the first characteristic data is the voiceprint data, the second characteristic data is the expression data; and when the first characteristic data is the expression data, the second characteristic data is the voiceprint data.

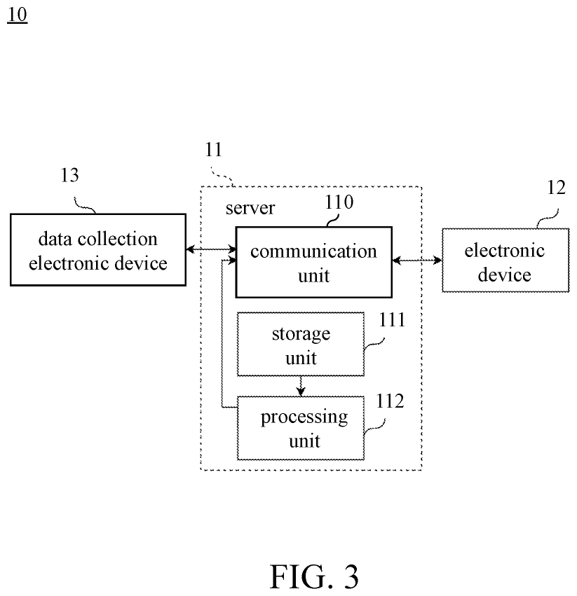

In the present embodiment, as shown in FIG. 3, the server 11 comprises a communication unit 110, a storage unit 111 and a processing unit 112, the communication unit 110 is linked to the electronic device 12, and the processing unit 112 is connected to the communication unit 110 and the storage unit 111. The storage unit 111 stores preset user information. When a user intends to use the teaching feedback system 10 of the present disclosure, the communication unit 110 obtains user information from the electronic device 12, and transmits the user information to the processing unit 112. The processing unit 112 obtains the preset user information from the storage unit 111, and compares the user information with the preset user information to determine whether the user information is consistent with the preset user information. If the user information is the same as the preset user information, it is determined that the user information is consistent with the preset user information, the user data model is established according to the user information corresponding to the user, and the selected first data model or the selected second data model, and the user information is stored in the storage unit 111. If the user information is not consistent with the preset user information, the user data model is not established according to the user information.

In the present embodiment, the first data model and the second data model are stored in the storage unit 111.

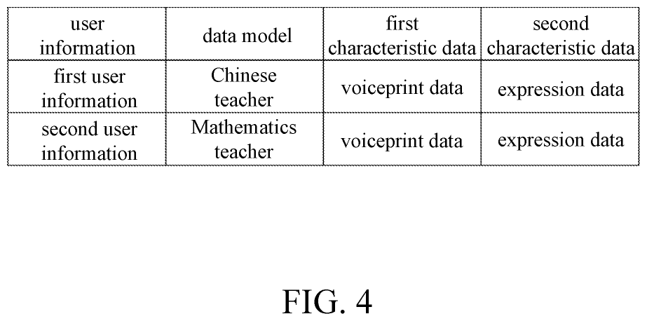

For example, as shown in FIG. 4, the data models comprise the first data model for a Chinese teacher and the second data model for a Mathematics teacher, the first characteristic data is the voiceprint data, the second characteristic data is the expression data, and the server 11 establishes the first data model and the second data model according to the voiceprint data and the expression data. After the server 11 completes the identification of first user information and second user information, the server 11 transmits the voiceprint data and the expression data to the electronic device 12. Then, after a first user selects the voiceprint data and the expression data, the electronic device 12 generates the demand signal. Next, the electronic device 12 transmits the demand signal, and the voiceprint data and the expression data selected by the first user to the server 11, and the server 11 establishes a user data model according to the first user information corresponding to the first user, the selected voiceprint data, and the selected expression data. Furthermore, when a second user has finished selecting the voiceprint data and the expression data, a user data model is established corresponding to the second user information. Thus, when the user uses the teaching feedback system 10 next time, after identifying the user information, the server 11 provides the voiceprint data and the expression data required by the user according to the user data model corresponding to the user information.

In the present embodiment, when a user selects the first data model, the processing unit 112 calculates the number of selections for the selected first data model to generate a number of selection times of the first data model. When another user selects the second data model, the processing unit 112 calculates the number of selections for the selected second data model to generate a number of selection times of the second data model. Further, the processing unit 112 compares the number of selection times of the first data model with the number of selection times of the second data model, to determine whether the number of selection times of the first data model is greater than the number of selection times of the second data model. If the number of selection times of the first data model is greater than the number of selection times of the second data model, the first data model corresponding to the number of selection times of the first data model is set as a default model. If the number of selection times of the second data model is greater than the number of selection times of the first data model, the second data model corresponding to the number of selection times of the second data model is set as the default model. In this way, when a new user initially uses the teaching feedback system 10 of the present disclosure, the default model can be provided to the new user, so as to better meet the needs of the user, and avoid the user from selecting the data model multiple times, resulting in time-consuming. In the present embodiment, when the sum of the number of selection times of the first data model and the number of selection times of the second data model reaches a threshold value, it is determined whether the number of selection times of the first data model is greater than the number of selection times of the second data model, to provide a data model that more closely meets user needs.

In the present embodiment, the storage unit 111 further stores a selection threshold value, and the processing unit 112 compares the number of selection times of the first data model and the number of selection times of the second data according to the selection threshold value, to determine whether the number of selection times of the first data model or the number of selection times of the second data is less than the selection threshold value respectively. When the number of selection times of the first data model is less than the selection threshold value, the first data model corresponding to the number of selection times of the first data model is deleted. When the number of selection times of the second data model is less than the selection threshold value, the second data model corresponding to the number of selection times of the second data model is deleted. When the number of selection times of the first data model or the number of selection times of the second data model is greater than the selection threshold value, the number of selection times of the first data model is compared with the number of selection times of the second data model, to determine whether the number of selection times of the first data model is greater than the number of selection times of the second data model.

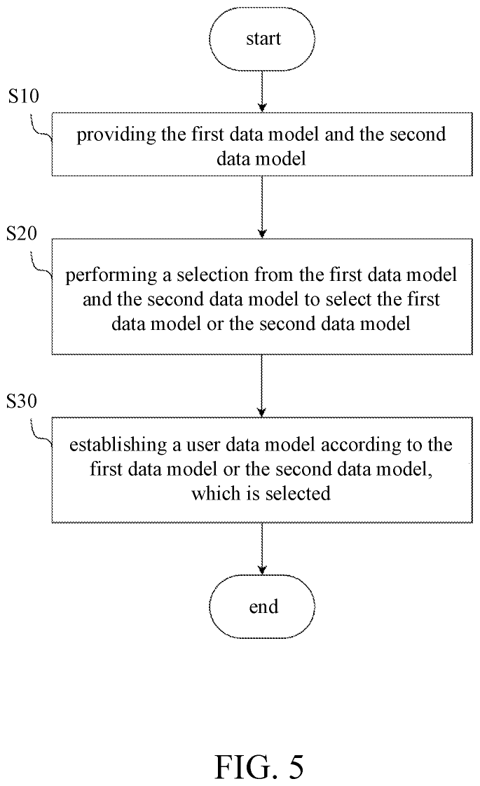

In addition, the preferred embodiment of a teaching feedback method of the present disclosure is shown in FIG. 5. The teaching feedback method is applied in a teaching feedback system, the teaching feedback system pre-establishes a first data model and a second data model, and the teaching feedback method performed by the teaching feedback system comprises the following steps: providing the first data model and the second data model (S10); performing a selection from the first data model and the second data model to select the first data model or the second data model (S20); and establishing a user data model according to the first data model or the second data model, which is selected (S30).

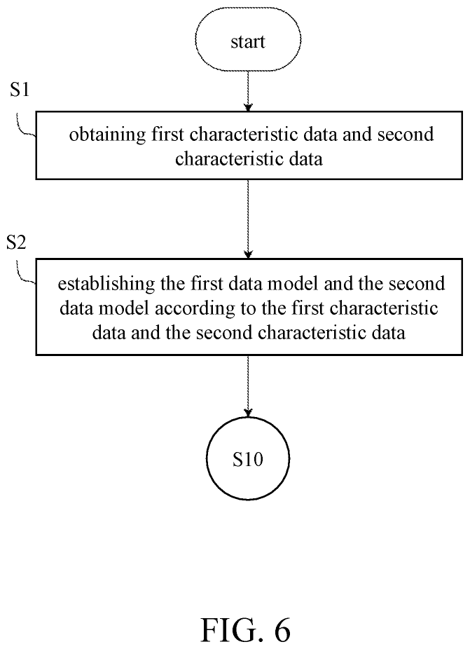

In the present embodiment, as shown in FIG. 6, before the step S10 of providing the first data model and the second data model, the teaching feedback method further comprises: obtaining first characteristic data and second characteristic data (S1); and establishing the first data model and the second data model according to the first characteristic data and the second characteristic data (S2).

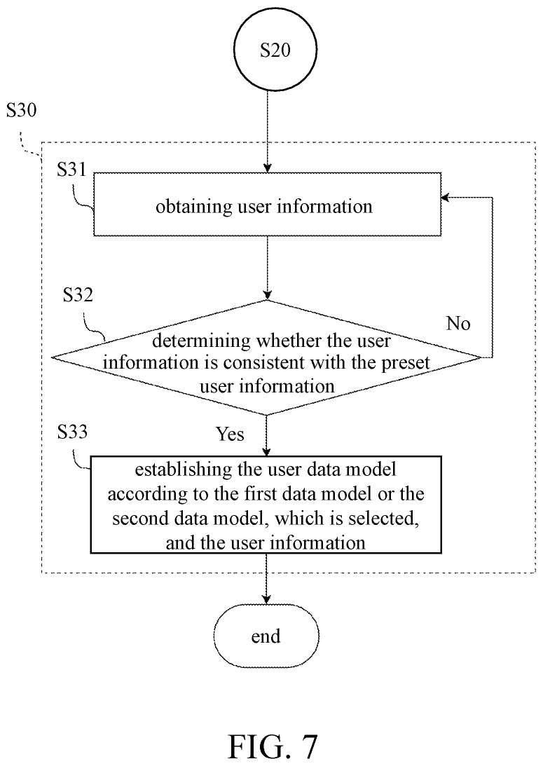

In the present embodiment, as shown in FIG. 7, wherein the step S30 of establishing the user data model according to the first data model or the second data model, which is selected, comprises: obtaining user information (S31); comparing the user information with preset user information to determine whether the user information is consistent with the preset user information (S32); if yes, establishing the user data model according to the first data model or the second data model, which is selected, and the user information (S33); and if not, performing the step S31 of obtaining user information.

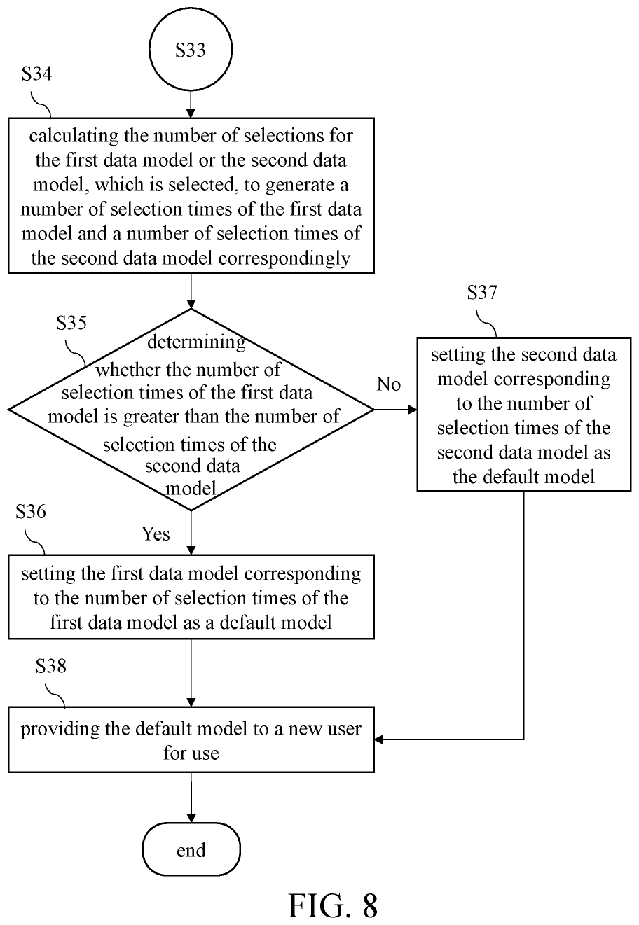

In the present embodiment, as shown in FIG. 8, after the step S33 of establishing the user data model according to the first data model or the second data model, which is selected, and the user information, the teaching feedback method further comprises steps: calculating the number of selections for the first data model or the second data model, which is selected, to generate a number of selection times of the first data model and a number of selection times of the second data model correspondingly (S34); comparing the number of selection times of the first data model with the number of selection times of the second data model, to determine whether the number of selection times of the first data model is greater than the number of selection times of the second data model (S35); if yes, setting the first data model corresponding to the number of selection times of the first data model as a default model (S36); if not, setting the second data model corresponding to the number of selection times of the second data model as the default model (S37); and providing the default model to a new user for use (S38).

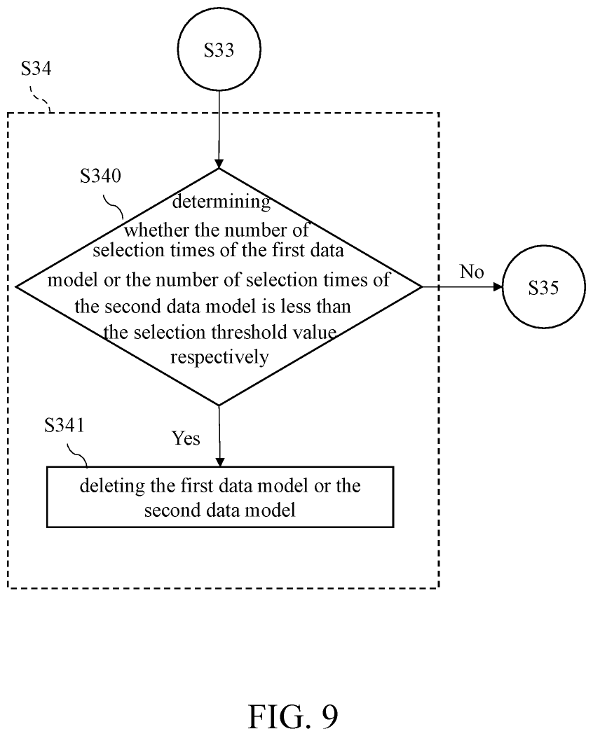

In the present embodiment, as shown in FIG. 9, the step S34 of calculating the number of selections for the first data model or the second data model, which is selected, to generate the number of selection times of the first data model and the number of selection times of the second data model correspondingly, comprises: comparing the number of selection times of the first data model and the number of selection times of the second data model according to a selection threshold value, to determine whether the number of selection times of the first data model or the number of selection times of the second data model is less than the selection threshold value respectively (S340); if yes, deleting the first data model corresponding to the number of selection times of the first data model, or deleting the second data model corresponding to the number of selection times of the second data model, and the remaining first data model or the remaining second data model is set as the default model (S341); and if not, performing the step S35 of comparing the number of selection times of the first data model and the number of selection times of the second data model, to determine whether the number of selection times of the first data model is greater than the number of selection times of the second data model.

In summary, the server 11 can provide the first data model and the second data model to the electronic device 12, and the user can select a data model from the first data model and the second data model, which meets his needs, and then the demand signal corresponding thereto is generated, and the selected first data model or second data model is transmitted to the server 11, so that the server 11 establishes the user data model according to the first data model or the second data model. Thus, the speaker can adjust the teaching method according to individual needs through the feedback of the needs, to achieve customization and provide a better learning effect.

It is to be understood that the term “comprise”, “include”, or any other variants thereof, is intended to encompass a non-exclusive inclusion, such that a process, method, article, or device of a series of elements not only comprise those elements but further comprises other elements that are not explicitly listed, or elements that are inherent to such a process, method, article, or device. Without further restrictions, an element defined by the phrase “comprising a . . . ” does not exclude the presence of the same element in the process, method, article, or device that comprises the element.

The embodiments of the present disclosure are described above with reference to the accompanying drawings, but the present disclosure is not limited to the above-mentioned specific embodiments, and the above-mentioned specific embodiments are only illustrative and not restrictive. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. A teaching feedback system, comprising:
a server, configured to pre-establish a first data model and a second data model; and
an electronic device, linked to the server;
wherein the server transmits the first data model and the second data model to the electronic device; the electronic device performs a selection according to the first data model and the second data model, to generate a demand signal, and a selected first data model or a selected the second data model, and transmits the selected first data model or the selected second data model to the server; and the server establishes a user data model according to the selected first data model or the selected second data model.

2. The teaching feedback system according to claim 1, further comprising:
a data collection electronic device, linked to the server, and configured to collect first characteristic data and second characteristic data, and transmit the first characteristic data and the second characteristic data to the server;
wherein the server establishes the first data model and the second data model according to the first characteristic data and the second characteristic data.

3. The teaching feedback system according to claim 1, wherein the server comprises:
a communication unit, linked to the electronic device, and configured to receive user information from the electronic device;
a storage unit, configured to store preset user information; and
a processing unit, connected to the communication unit and the storage unit;
wherein the processing unit compares the user information with the preset user information to determine whether the user information is consistent with the preset user information; and if yes, the processing unit establishes the user data model according to the user information, and the selected first data model or the selected second data model.

4. The teaching feedback system according to claim 3, wherein the processing unit calculates the number of selections for the selected first data model to generate a number of selection times of the first data model, and calculates the number of selections for the selected second data model to generate a number of selection times of the second data model.

5. The teaching feedback system according to claim 4, wherein the storage unit stores a selection threshold value; the processing unit compares the number of selection times of the first data model and the number of selection times of the second data model according to the selection threshold value, to determine whether the number of selection times of the first data model or the number of selection times of the second data model is less than the selection threshold value; and if yes, the processing unit deletes the first data model or the second data model.

6. A teaching feedback method, applied to a teaching feedback system, which pre-establishes a first data model and a second data model, the teaching feedback method performed by the teaching feedback system comprising the following steps:
providing the first data model and the second data model;
performing a selection from the first data model and the second data model to select the first data model or the second data model; and
establishing a user data model according to the first data model or the second data model, which is selected.

7. The teaching feedback method according to claim 6, wherein before the step of providing the first data model and the second data model, the teaching feedback method further comprises:
obtaining first characteristic data and second characteristic data; and
establishing the first data model and the second data model according to the first characteristic data and the second characteristic data.

8. The teaching feedback method according to claim 6, wherein the step of establishing the user data model according to the first data model or the second data model, which is selected, comprises:
obtaining user information;
comparing the user information with preset user information to determine whether the user information is consistent with the preset user information; and
if yes, establishing the user data model according to the first data model or the second data model, which is selected, and the user information.

9. The teaching feedback method according to claim 6, wherein after the step of performing the selection from the first data model and the second data model to select the first data model or the second data model, the teaching feedback method further comprises:
calculating the number of selections for the first data model or the second data model, which is selected, to generate a number of selection times of the first data model and a number of selection times of the second data model correspondingly;
comparing the number of selection times of the first data model with the number of selection times of the second data model, to determine whether the number of selection times of the first data model is greater than the number of selection times of the second data model;
if yes, setting the first data model corresponding to the number of selection times of the first data model as a default model; and
if not, setting the second data model corresponding to the number of selection times of the second data model as the default model.

10. The teaching feedback method according to claim 9, wherein the step of calculating the number of selections for the first data model or the second data model, which is selected, to generate the number of selection times of the first data model and the number of selection times of the second data model correspondingly, comprises:
comparing the number of selection times of the first data model and the number of selection times of the second data model according to a selection threshold value, to determine whether the number of selection times of the first data model or the number of selection times of the second data model is less than the selection threshold value respectively;
if yes, deleting the first data model or the second data model; and
if not, performing the step of performing the selection from the first data model and the second data model to select the first data model or the second data model.
